(19) United States
(12) Patent Application Publication
(10) Pub. No.: US 2005/0256719 A1
(43) Pub. Date: Nov. 17, 2005

(54) Voice-activated remote control

(76) Inventor: Stacy L. VanOrman, Alpena, MI (US)

Correspondence Address: HARSHAW RESEARCH INCORPORATED, P O BOX 418, OTTAWA, KS, 66067, US

(21) Appl. No.: 10/844,151

(22) Filed: May 12, 2004

(51) Int. Cl. G10L 21/00

(52) U.S. Cl. 704/275

(57) ABSTRACT

A voice activated remote control for an appliance broadly includes a receiver for receiving audible commands of a user, a transmitter for transmitting signals to the appliance, and a central processing unit (CPU) in communication with the receiver and transmitter for interpreting the audible commands received by the receiver. The CPU includes a programmable memory accessible by the CPU storing data representing a title, a playing time and playing channel of a predetermined program. The CPU is configured to interrogate the memory of the control to determine if the appliance is tuned to the playing channel during the playing time of the program, and causes an aural query to be broadcast by the control when the appliance is not tuned to the playing channel during the playing time of the program.

### BACKGROUND OF THE INVENTION

1. Field of the Invention

The present invention relates generally to a remote control for an appliance. More particularly, the remote control of the present invention is a voice-activated remote control used in prompting a user to tune an appliance to a predetermined program, and for passive recording of transmissions of the appliance.

2. Discussion of the Prior Art

Remote controls have long been known in the art of tuning appliances. A common remote control is push button controlled to generate signals transmitted by an infrared light emitting diode (LED). These signals are received by the appliance, such as a television (TV) or video cassette recorder (VCR) or digital video disc (DVD) player, causing the appliance to be tuned to a particular channel or adjusted in some fashion, such as volume control. While remote controls may be used to program an appliance, they are not user-programmable themselves, and rely on specific inputs made by a user, only generating signals at the general time that the user pushes a desired button.

Voice recognition technology is a relatively fast growing field that has been applied in many areas making the control of machines and input of data into databases generally easier. Such voice recognition technology has not heretofore been used in the area of remote controls for appliances. The present invention couples the voice recognition technology with a remote control in a unique and novel manner yielding a remote control having more capabilities than prior art remote controls.

### BRIEF SUMMARY OF THE INVENTION

A voice activated remote control for an appliance broadly comprises a receiver for receiving audible commands of a user, a transmitter for transmitting signals to the appliance, and a central processing unit (CPU) in communication with the receiver and transmitter for interpreting the audible commands received by the receiver. The CPU includes a memory accessible by the CPU, and a timer or clock.

The memory includes a plurality of partitions. The first partition is a show memory in which data is stored representing a title, a playing time and playing channel of a predetermined program. The CPU is configured to interrogate the memory of the control and the appliance to determine if the appliance is tuned to the playing channel during the playing time of the program, and causes an aural query to be broadcast by the remote control when the appliance is not tuned to the playing channel during the playing time of the program. The query prompts the user to tune the appliance to air the program. This is accomplished using a voice command received by the remote control, or by button inputs.

A second memory partition includes a cache memory in which a predetermined amount of audio and/or video transmissions of the program being aired by the appliance is stored. Recording of transmissions in the cache memory is looped so that only the most recent predetermined amount of transmissions is held in the cache memory. Upon the command of the user of the remote control, the cache memory may be transferred into a third partition, referred to as the message memory, creating a message for selective airing. The user, anticipating the need for recording the program, may also record a selected portion of the program and place the recording in the message memory in the form of a message for later airing. A message counter retains the value of the current number of messages in message memory.

### BRIEF DESCRIPTION OF THE SEVERAL VIEWS OF THE DRAWINGS

A preferred embodiment of a voice activated remote control is described in detail below with reference to the drawing figures, wherein:

FIG. 1 is a perspective view of the remote control;

FIG. 2 is a block diagram of the remote control;

FIG. 3 is a flow chart of the prompting functions of the remote control; and

FIG. 4 is a flow chart of the recording features of the remote control.

### DETAILED DESCRIPTION OF THE PREFERRED EMBODIMENT

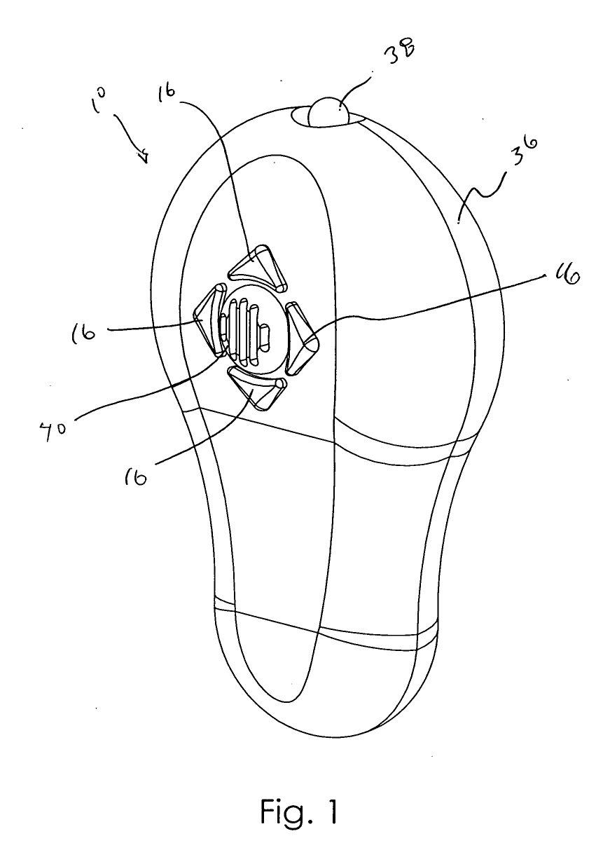

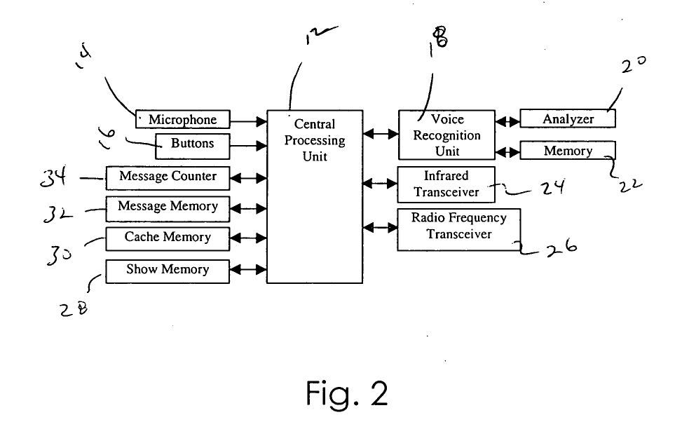

Referring now to the drawings, FIGS. 1-4 depict a preferred embodiment 10 of a voice-activated remote control. As shown in FIG. 2, the preferred remote control 10 includes a central processing unit (CPU) 12, and an integrated microphone and speaker 14 and buttons 16 in communication with the CPU 12 for entry of user selected data in the control. A voice recognition unit (VRU) 18 having an analyzer 20 and VRU memory 22 is provided for interpreting voice commands given by a user and received by the microphone 14. An infrared (IR) transceiver 24 and a radio frequency (RF) transceiver 26 are provided for transmitting and receiving signals to and from an appliance.

Memory is provided for storing data in the remote control 10. The memory includes a show memory 28, a cache memory 30, and a message memory 32. A clock is included in the CPU 12 for tracking the current time and date.

The show memory 28 is used for storage of data representing a title, playing time and a playing channel of a user selected or predetermined program. This data is inputted in the show memory 28 by the user via the microphone 14 and VRU 18. Data representing the titles, playing times and playing channels of multiple selected programs may be stored in the show memory 28.

In addition, the remote control 10 may be configured to record title, playing time and playing channel information of programs most frequently watched by a user. When the TV is tuned to the same channel on the same day of the week multiple times, the remote control 10 may issue a query to the user asking if the control 10 should be programmed to list that program as a desired program for reminding in the future. Pattern recognition software in the CPU 12 would recognize daily program watching habits. The software works by creating an array with playing times and days in one direction and the playing channels watched in the other direction. When a predetermined threshold of watching is exceeded either by number of times watched or by percentage of times watched out of a total TV watching time, the control 10 queries the user if the program should be listed as a favorite program.

During operation of the appliance, audio transmissions of the program are received by the microphone. These transmissions are recorded in a continuous loop in the cache memory 30 for selective replaying by the user. The preferred loop is 30 seconds of audio transmissions, so that the most recent 30 seconds of audio transmissions are held in the cache memory 30.

Alternatively, RF and/or IR signals transmitted by the appliance are received by the transceivers 24 and 26 of the remote control 10. These appliance signals are representative of audio and/or video transmissions of the appliance, and are recorded in a continuous loop in the cache memory 30 for selective replaying by the user. The preferred loop is 30 seconds of audio and/or video transmissions, so that the most recent 30 seconds of audio and/or video transmissions are held in the cache memory 30. Another method of the remote control 10 communicating with the appliance is through the use of a conventional electrical cable, such as a coaxial cable.

The CPU 12 has a record back function that may be activated by the user using voice commands via the VRU 18 or using the buttons 16. Activation of the record back function causes the most recent 30 seconds of audio and/or video transmissions to be transferred to the message memory 32 in the form of a message. Multiple messages may be stored in the message memory 32. A message counter 34 keeps track of the number of messages stored in the message memory 32.

The CPU 12 also includes a play back function activated by voice commands via the VRU 18 or by button selection using the buttons 16 for playing a selected message on the appliance at a desired time. As a result, when the user is viewing or listening to a program, and is interrupted and misses a segment of the program, the record back function is used to generate a message and store the message in the message memory 32. When the interruption passes, the user may then play the message and view or listen to the segment of the program that was missed. When an audio message, the message may be replayed by the control 10.

The CPU 12 also includes a record forward function enabling a user to record a predetermined segment of a program in anticipation of an impending interruption from the time a record forward command is given to the remote control 10 until a record stop command is given. The segment is stored as a message in the message memory 32 for selective airing on the appliance, or by the remote control 10.

The preferred remote control 10 is shown in FIG. 1. The remote control 10 presents an ergonomic body 36 constructed from synthetic resin material. The IR transceiver 24 includes a light emitting diode (LED) 38 for transmission of signals to the appliance and an IR receiver (not shown) for receiving signals from the appliance. An internal antenna (not shown) is used for transmitting and receiving RF signals to and from the appliance. A microphone cover 40 is provided for protecting the microphone 14 and for permitting reception of voice commands from the user by the microphone 14 and broadcasting of messages and prompts by the control 10. The remote control 10 is sized to fit comfortably in the hand of the user.

Modem entertainment systems often include appliances such as a television (TV), a video cassette recorder (VCR) and/or a digital video disc (DVD) player. In addition, such a system may also include appliances for playing audio media, such as a radio, or tuner, a compact disc (CD) player, a cassette player and even an album or record player. These appliances are manufactured by many different manufacturers and each utilize different signals for controlling the appliances. The preferred remote control 10 may be set for compatibility with any of a various number of appliances manufactured by the various manufacturers. The control 10 may be reset whenever needed for use with a different appliance.

The CPU 12 utilizes spotting logic to increase the accuracy of the control of the desired appliance. Using this logic, the VRU 18 first recognizes a spotting word to select an appliance for control. The spotting word may be “TV” or “VCR” or “DVD,” etc., preparing the remote to transmit signals to the selected appliance. Once the spotting word is received and recognized by the VRU 18, the VRU 18 “listens” for a command word, such as “on,” “off,” or “mute,” etc. Once the command word is received and recognized by the VRU 18, the CPU 12 generates a signal for transmission to the appliance, in order to control the appliance. The VRU 12 may be programmed by a user so that a special pet name for an appliance may be substituted for the conventional appliance name.

It will be appreciated that by using spotting logic, accuracy of the remote control 10 is increased by requiring the use of two words before a signal is transmitted to the appliance for control thereof. Using a two word command structure also minimizes the number of accidental or unintended signals being transmitted due to the microphone picking up noises similar to command words.

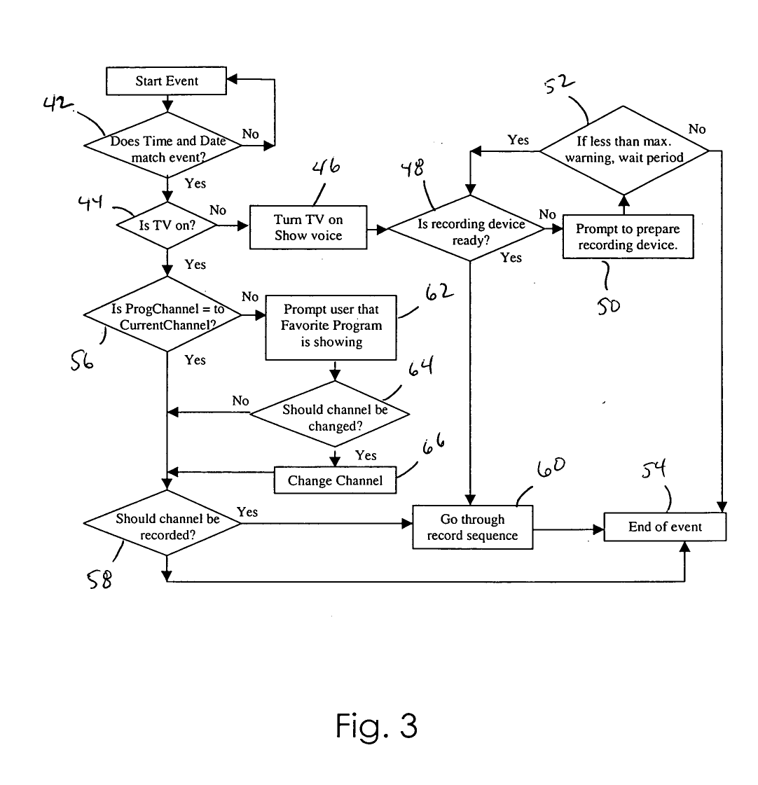

Turning now to FIG. 3, a flow chart of a program reminding feature of the remote control 10 is shown. The title, playing time and date and playing channel of a favored program aired on TV is stored by the user in the show memory 28. The CPU 12 first compares the current time and date against the playing time and date step 42. When there is a match, the CPU 12 interrogates the TV using one of the transceivers 24, 26 to determine if the TV is turned on in step 44. If the TV is off, the CPU 12 generates a signal transmitted by the transceiver 24 turning the TV on in function 46.

Alternatively, the TV may be left off, and a VCR or DVD player/recorder is activated by the remote control 10 for recording the program. Prior to activating the VCR or DVD player/recorder, the CPU 12 interrogates the recorder to determine if the device is ready for recording in step 48. When the device is not ready, an aural prompt is broadcast by the control 10 prompting the user to prepare the recorder for recording the program in function 50. In step 52, the control 10 will wait a predetermined time before interrogating the recorder again in step 48. Once the control 10 has cycled trhough a predetermined number of interrogations of the recorder, the prompting of function 52 will be ended in function 54.

When the TV is on, the CPU 12 interrogates the TV to determine if the TV is tuned to the playing channel in step 56. When the TV is tuned to the playing channel, the CPU 12 generates an aural query or prompt broadcasted by the control asking the user if the program should be recorded in step 58. Alternatively, the CPU 12 generates a signal transmitted by the control 10 to the TV so that he TV displays a prompt asking the user if the program should be recorded. The user utilizes the voice command capability of the control 10 to answer the prompt in the affirmative or negative. When the answer is in the affirmative, the recorder will be signalled by the control 10 to record the program in function 60.

Should the TV not be tuned to the playing channel, the CPU 12 acts as a query means by generating an aural query or prompt asking the user whether the TV should be tuned to the playing channel in function 62 and step 64. Alternatively, the CPU 12 generates a signal transmitted to the TV so that the TV displays a prompt asking the user if the TV should be tuned to the playing channel. The user utilizes the voice command capability to answer this question in the affirmative, in which case the control automatically generates a signal to the TV tuning it to the playing channel in function 66, or the negative. Once this prompt is answered, the CPU 12 goes through the recording prompt sequence in step 58 and function 60, as outlined above.

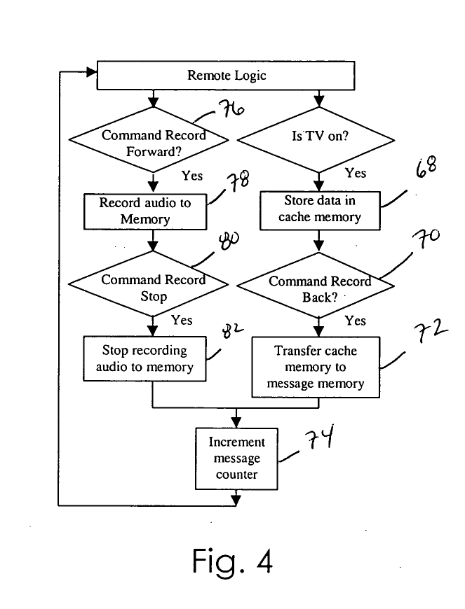

The record back and record forward functions of the control 10 are shown in a flow diagram in FIG. 4. When the TV is on, the cache memory 30 stores the immediately previous 30 seconds of the program aired by the TV in function 68. The control 10 may be programed to store audio, video or both transmissions from the TV in the cache memory 30. When the user issues a voice command to “record back” in step 70, the CPU 12 generates a message representing the most recent 30 seconds of programming, the current contents of the cache memory 30, and stores the message in the message memory 32 for selective replaying by the user in function 72. The message counter 34 is configured to keep track of the number of messages currently stored in the message memory 32 as shown in function 74. The message counter 34 decreases its value when a message is erased from the message memory 32.

When the transmissions are audio, they may be captured by the microphone 14, and aired or broadcast directly from the remote control 10. However, when the transmissions include video transmissions, current technology requires that the control 10 be electronically coupled with the TV by conventional means, such as a coaxial cable or the like, for replaying the video transmissions on the TV, or be in IR or RF communication with the TV. It will be appreciated that the record back function is handy when a phone number, street address or web address has been issued on the TV and the user was not able to record the number or address using pen and paper or their own memory.

The record forward function generates a message in real time by recording the audio, video or both transmissions of the TV upon the command of a user until a stop command is received. The message is recorded directly to the message memory 32 for selective replaying by the user.

As shown in the flow chart of FIG. 4, when the command by a user is given to record forward, step 76, the transmissions are recorded directly into the message memory 32, function 78. Once the command to stop recording is given by the user in step 80, the control 10 stops recording the transmissions in function 82. The recording is held in the message memory 32 as a message, and the message counter 34 increases its value by one in function 74.

The remote control 10 constructed in accordance with the preferred embodiment may be used in a similar fashion with stereos or other audio transmitting appliances to prompt a user to tune the appliance to a playing channel for listening to a desired program.

The invention has been described in the above preferred embodiments with reference to the drawing figures. It is understood that substitutions may be made and equivalents employed herein without departing from the scope of the invention as set forth in the following claims.

1. A voice activated remote control for an appliance, the control comprising:
a receiver for receiving audible commands of a user;
a transmitter for transmitting signals to the appliance;
a central processing unit (CPU) in communication with the receiver and transmitter, the CPU including means for interpreting the audible commands received by the receiver;
a show memory accessible by the CPU storing data representing a title, a playing time and playing channel of a predetermined program, and the CPU including query means for interrogating the show memory of the control and the appliance to determine if the appliance is tuned to the playing channel during the playing time of the program, and for causing an aural query prompting the user to tune the appliance to the playing channel when the appliance is not tuned to the playing channel during the playing time of the program.

2. The remote control as set forth in claim 1, wherein the show memory is programmable so that data representing a title, a playing time and a playing channel of a selected program may be stored in the show memory by the user.

3. The remote control as set forth in claim 1, wherein the show memory is programmable and audible commands received by the receiver are used to program the show memory of the CPU.

4. The remote control as set forth in claim 1, wherein the show memory includes title, playing time and playing channel information for a plurality of programs.

5. The remote control as set forth in claim 1, wherein the aural query includes the title of the program.

6. The remote control as set forth in claim 1, the control further including means for recording audio transmissions from the appliance in a message memory accessible by the CPU.

7. The remote control as set forth in claim 1, the control further including a cache memory accessible by the CPU for storing audio transmissions from the appliance, the cache memory recording the audio transmissions in a continuous loop so that a predetermined duration of most recent audio transmissions is stored in the cache memory.

8. The remote control as set forth in claim 7, the control further including means for transferring the duration of most recent audio transmissions stored in the cache memory into a message memory for selective replaying of the duration of most recent audio transmissions.

9. The remote control as set forth in claim 7, the control further including means for recording video transmissions by the appliance and storing a predetermined duration of most recent video transmissions in the cache memory.

10. The remote control as set forth in claim 1, the interrogating means further determining whether the appliance is off, and when the appliance is off, sending a transmission signal to a recording device causing the recording device to record the program.

11. A voice activated remote control for an appliance, the control comprising:
a receiver for receiving audible commands of a user and for receiving transmissions from the appliance;
a transmitter for transmitting signals to the appliance;
a central processing unit (CPU) in communication with the receiver and transmitter and including means for interpreting the audible commands received by the receiver;
a show memory accessible by the CPU storing data representing a title, a playing time and playing channel of a predetermined program; and
a cache memory accessible by the CPU storing the transmissions from the appliance, the cache memory recording the transmissions in a continuous loop so that a predetermined duration of most recent transmissions is stored in the cache memory.

12. The remote control as set forth in claim 11, the control further including means for transferring the duration of most recent transmissions stored in the cache memory into a message memory for selective replaying of the duration of most recent transmissions.

13. The remote control as set forth in claim 11, wherein the transmissions are audio transmissions.

14. The remote control as set forth in claim 11, wherein the transmissions are video transmissions.

15. The remote control as set forth in claim 11, the CPU further including query means for interrogating the show memory of the control to determine if the appliance is tuned to the playing channel during the playing time of the program, and for causing signals to be transmitted by the transmitter so that a query is displayed on the appliance when the appliance is not tuned to the playing channel during the playing time of the program.

16. A method for prompting a user of an appliance to tune the appliance to a program, the method comprising the steps of:
providing a voiced activated remote control including a receiver, a transmitter, and a central processing unit (CPU) in communication with the receiver and transmitter and having a memory for storage of data representing a title, a playing time and a playing channel of a program;
storing data in the memory representing the title, playing time and playing channel of the program;
interrogating the appliance during the playing time to determine whether the appliance is tuned to the playing channel of the program;
generating a query prompting the user to tune the appliance to the playing channel when the appliance is not tuned to the playing channel during the playing time; and
broadcasting the query when the appliance is not tuned to the playing channel during the playing time.

17. The method as set forth in claim 16, further including the step of transmitting a signal to the appliance to turn the appliance on when the appliance is off during the playing time.

18. The method as set forth in claim 16, further including the step of transmitting a signal to a recording device to record the program when the appliance is off.

19. The method as set forth in claim 16, further including the step of transmitting signals to the appliance so that the a prompt is displayed on the appliance prompting the user to tune the appliance to the playing channel.
